(19) United States
(12) Patent Application Publication
(10) Pub. No.: US 2003/0224224 A1
(43) Pub. Date: Dec. 4, 2003

(54) Power supply system

(75) Inventors: Yukihiro Okada, Osaka (JP); Satoshi Shibutani, Osaka (JP); Aoi Tanaka, Osaka (JP); Nobuhiko Hojo, Osaka (JP); Yasutaka Noguchi, Naga-gun Wakayama (JP); Kohji Yuasa, Osaka (JP)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: Matsushita Electric Industrial Co., Ltd.

(21) Appl. No.: 10/441,853

(22) Filed: May 20, 2003

(30) Foreign Application Priority Data
May 22, 2002 (JP) JP2002-147766

(51) Int. Cl. H01M 16/00; H01M 8/04

(52) U.S. Cl. 429/7; 429/9; 429/26

(57) ABSTRACT

A power supply system is provided having a fuel cell and a power storage source comprising at least one of a secondary battery and a capacitor, the power supply system being secured to or mounted, in use thereof, on an electronic equipment, wherein: the fuel cell has a maximum output power which is higher than the average power consumption of and lower than the maximum power consumption of the electronic equipment; and the power storage source can output at least a power corresponding to the maximum power consumption of the electronic equipment. The power supply system can start the operation of electronic equipment having a high load even at the time of starting such operation, irrespective of the ambient temperature; can operate the electronic equipment for a long time by simply refilling the fuel supply; and can be low in cost, small in size and high in reliability and output energy density.

### BACKGROUND OF THE INVENTION

The present invention relates to a power supply system using a fuel cell, more particularly to a power supply system to be used for powering electronic or electric equipment, typically portable equipment, such as notebook personal computer and cellular phone, and to electronic equipment having the power supply system mounted thereon or secured thereto.

A battery is currently used for powering portable electronic equipment. However, because of requirements of higher power consumption and longer operation time of such portable electronic equipment, a fuel cell, which has the potential of higher energy density, is coming to the fore.

A fuel cell having a high output is needed for portable equipment having a high load. However, the output per unit volume of a fuel cell is generally lower than that of a battery. Accordingly, a fuel cell has the problems of high cost and large size. Another problem of a fuel cell is that a sufficient power output cannot be obtained by the fuel cell alone when the ambient temperature is low.

For example, Japanese Patent Publications 2001-28807 and 2001-95107 propose to combine a fuel cell and a power storage source for obtaining a sufficient power output.

In Japanese Patent Publication 2001-28807, a technology of starting the operation of a fuel cell by using a secondary battery is disclosed. A fuel cell having a high output is needed therein for bearing the maximum power consumption of the electronic equipment, because the fuel cell is used as a power supply for driving the electronic equipment. However, the output power which can be produced per unit area of a current fuel cell, is small. Accordingly, in order to obtain a higher output, it becomes necessary to either produce a fuel cell having a larger electrode area or increase the number of unit cells of a fuel cell, making it difficult to commercialize such a fuel cell from the viewpoint of cost. Furthermore, such a fuel cell would be larger in size, so that it becomes difficult to power small-sized portable equipment such as a notebook personal computer, a personal digital assistant (PDA) or a cellular phone, using such fuel cell.

According to Japanese Patent Publication 2001-95107, a fuel cell is used as power for a base load, and a secondary battery is used as an auxiliary power for an excessive load over the base load. It is described there in that the power supply system can efficiently bear the load. However, when the ambient temperature is low such as 0° C. at the time of starting the operation of the electronic equipment, the fuel cell scarcely contributes to the power output, so that the power supply system needs to reply on the output of the secondary battery. Particularly in the case of portable equipment such as notebook personal computer, highest power is needed at the time of starting. Accordingly, if it is attempted to make the secondary battery bear the excessive load over the base load, there is a possibility that such electronic equipment when operating with its maximum load at the time of starting cannot start.

In Japanese Patent Publication 2001-95107, it is described furthermore that when the secondary battery has a remaining charge amount which is lower than a predetermined value, a greater portion of the base load is borne by the fuel cell, thereby charging the secondary battery. When the maximum output of the fuel cell is lower than the average power consumption of the electronic equipment, the charge amount of the secondary battery gradually decreases, and in some cases the power supply system becomes unable to bear the high load while the electronic equipment is used. On the other hand, if the fuel cell is designed to have an unnecessarily high maximum power output, it causes a disadvantage in terms of its cost and size.

According to the present specification, the term “electric capacity” is used to mean the amount of capability of storing electric charge, while the term “charge amount” is used to mean the amount of charge stored, e.g., in the power storage source.

In the case of a hybrid power supply system having a combination of a fuel cell and, e.g., a secondary battery, there is such undesirably high possibility as follows. When e.g. the secondary battery deteriorates, whereby its electric capacity and output power become low, the entire power supply system may become unusable, even though the fuel cell itself does not deteriorate. Moreover, the deterioration, e.g., of the secondary battery is likely to accelerate when the ambient temperature rises. Further, the temperature of the fuel cell is likely to rise, since the fuel cell utilizes an exothermic reaction, e.g., between hydrogen and oxygen or between methanol and oxygen.

Currently, it is attempted to maintain the temperature of the fuel cell within a predetermined range by supplying air to the air electrode. However, from the viewpoint of the performance per se of the fuel cell, such as its output power, a higher temperature is preferred . For example, it is desirable to operate the power generation of the fuel cell with the temperature being controlled to be at about 40° C., whereby in such case, the heat of the fuel cell is transferred to the secondary battery. Accordingly, the temperature of the secondary battery rises as described above, thereby quickly shortening the life of the secondary battery. Particularly since the portable equipment is small in size, there is a problem that storage batteries like the secondary battery are likely to be influenced by the heat of the fuel cell.

### BRIEF SUMMARY OF THE INVENTION

The present invention solves the above-described problems to provide a power supply system comprising a power storage source and a fuel cell, wherein the power supply system (1) is neither high in cost nor large in size; (2) can securely produce sufficient output power from the initial operation irrespectively of the ambient temperature; (3) can be operated for a long time; and (4) and has a high energy density and reliability.

To solve the above-described problems, the present invention provides a power supply system comprising a fuel cell and a power storage source comprising at least one of a secondary battery and a capacitor, the power supply system being secured, in use thereof, to an electronic equipment, wherein: the fuel cell has a maximum output power which is higher than the average power consumption of and lower than the maximum power consumption of the electronic equipment; and the power storage source can output at least a power corresponding to the maximum power consumption of the electronic equipment.

According to such power supply system, it is preferred that the maximum output power of the fuel cell be not higher than twice the average power consumption of the electronic equipment.

Further, the power storage source is preferred to have a maximum output power which is not higher than twice the maximum power consumption of the electronic equipment.

Furthermore, the power storage source is preferred to have an electric capacity capable of starting the operation of the electronic equipment at least five times.

It is further preferred that the power storage source be thermally insulated from the fuel cell.

Here, the power storage source is preferred to be thermally insulated from the fuel cell, e.g., by a space and/or a heat insulator provided between the fuel cell and the power storage source.

It is preferred that the power supply system further comprise a cooling means for cooling the power storage source, using air supplied to the fuel cell.

It is moreover preferred that the power supply system further comprise a controller which detects the amount of fuel supplied to the fuel cell, and which stops output of the power supply system when the supplied fuel is detected to have become exhausted.

The present invention additionally provides an electronic equipment having, secured thereto, such power supply system as described above.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. While the novel features of the invention are set forth particularly in the appended claims, the invention, both as to organization and content, will be better understood and appreciated, along with other features thereof, from the following detailed description taken in conjunction with the drawings. It should be understood, however, that the invention is not limited to the precise arrangements and instrumentalities shown.

In the drawings:

FIG. 1 is a schematic block diagram, showing a first preferred embodiment of a power supply system according to the present invention.

FIG. 2 is a schematic block diagram, showing a second preferred embodiment of a power supply system according to the present invention.

FIG. 3 is a schematic block diagram, showing a third preferred embodiment of a power supply system according to the present invention.

### DETAILED DESCRIPTION OF THE INVENTION

To solve the above-described problems, a power supply system according to the present invention is characterized in that it comprises a fuel cell and a power storage source comprising at least one of a secondary battery and a capacitor, the power supply system being secured to or mounted, in use thereof, on an electronic equipment, wherein: the fuel cell has a maximum output power which is higher than the average power consumption of and lower than maximum power consumption of the electronic equipment; and the power storage source can output at least a power corresponding to the maximum power consumption of the electronic equipment.

According to such structure, the power supply system, because of the output of the power storage source as described above, can bear the maximum power consumption of the electronic equipment using the power supply system, even at the time of starting the operation of the power supply system when there is an undesired possibility that the fuel cell scarcely produces any output power. The power supply system according to the present invention is particularly effective for electronic equipment that operates under a very heavy load at the time of starting the operation of the electronic equipment.

It is to be noted that the term “power storage source” according to the present specification is used to mean an element having a function of storing and charging/discharging electric power.

By setting the maximum output power of the fuel cell to be higher than the average power consumption of the electronic equipment, the power storage source can be prevented from becoming fully discharged. Further, by setting the maximum output of the fuel cell to be lower than the maximum power consumption of the electronic equipment, the fuel cell can avoid being unnecessarily large in size, and the cost of the fuel cell and hence the size and cost of the power supply system can be kept down.

It is preferred that the maximum output power of the fuel cell not be higher than twice the average power consumption of the electronic equipment. Thereby, the size and the cost of the fuel cell, and hence the size and cost of the power supply system, can be kept down.

Further, the power storage source is preferred to have a maximum output power which is not higher than twice the maximum power consumption of the electronic equipment. Thereby, the power supply system can be used for a long time, with the cost of the power storage source being kept down.

It is to be noted the “maximum output power of the power storage source” according to the present specification is defined as follows. The charge amount stored in the power storage source in correspondence with 100% of the electric capacity of the power storage source is defined as the full charge amount. The output power of the power storage source discharging at a discharge rate for discharging M% of the full charge amount is defined as the maximum output of the power storage source, where M% is 80% or higher. It is preferable that the charge amount in the power storage source can be consumed as much as possible in order to allow the power storage source to be as small in size and low in cost as possible. By designing the discharge rate to be slower, the dischargeable amount M% can be higher, such as 90% or 95%.

The reason for thus defining the maximum output of the power storage source is as follows. In the case of a very short discharge time, for example 0.1 sec, a very large current can be supplied by a power storage source such as lithium-ion battery. In such case, the value of the maximum output of the power storage source must be very large. However, if a too large current is supplied by the power storage source, the voltage of the power storage source decreases in a too short time, resulting in a situation where almost none of the full charge amount of the power storage source can be used. Accordingly, from a practical point of view, such way of obtaining maximum output of the power storage source is not preferable. Rather, as described above, it is preferred that at least 80% of the full charge amount of the power storage source can be consumed. This is the reason why the maximum output of the power storage source is defined in the manner as described above.

Furthermore, the power storage source is preferred to have an electric capacity capable of starting the operation of the electronic equipment at least five times. In the case of portable electronic equipment such as notebook personal computer, ON/OFF switching operation of power source is likely to be repeated. Since sufficient output power may not be obtained from the fuel cell particularly in the case, e.g., of low ambient temperature, the charge amount of the power storage source gradually decreases due to the ON/OFF switching operation. When the charge amount becomes too low, there is a possibility that the electronic equipment may become unable to be started.

In the power supply system according to the present invention, it is further preferred that the power storage source be thermally insulated from the fuel cell. Thereby, deterioration of the power storage source, and hence the entire power supply system, can be avoided.

Here, the power storage source is preferred to be thermally insulated from the fuel cell, e.g., by a space and/or a heat insulator (heat insulating material) provided between the fuel cell and the power storage source.

It is furthermore preferred that the power supply system according to the present invention further comprise a cooling means for cooling the power storage source, using air supplied to the fuel cell. Thereby, the temperature of the power storage source can be prevented from rising, thereby decreasing the speed of its deterioration.

It is moreover preferred that the power supply system according to the present invention further comprise a controller which detects the amount of fuel supplied to the fuel cell, and which stops the output of the power supply system when the supplied fuel is detected to have become exhausted, even if the power storage source may still have some remaining amount of charge. Thereby, the power storage source can be suppressed from becoming fully discharged, and the electronic equipment can be used as repeatedly as desired, by simply refilling the fuel supply.

Furthermore, portable electronic equipment is preferable as the electronic equipment having, in its use, the power supply system mounted thereon. This is because portable equipment can greatly enjoy the benefit of the effect according to the present invention.

As evident from the foregoing description, in order to realize a power supply system having a long operational life, small size, low cost and good capability of starting the operation of electronic equipment, it is very important to adopt the structure of the power supply system according to the present invention, and further preferable structures thereof.

As for the power storage source, capacitors or secondary batteries other than a lithium-ion battery can be used as well, in order to obtain similar effects. Further, it is preferable to always detect the remaining charge amount of the power storage source so as to not cause the power storage source to become fully discharged, and to maintain the same at an optimum charge amount. The electric capacity of the power storage source should be considered from the viewpoint of realizing a long life and a lengthened operational time period in which electronic equipment can be operated by the power storage source alone as well as realizing the required maximum output of the power supply system by the power storage source alone. From these considerations, it is preferable to maintain the charge amount of the power supply source in a range of 30 to 100%, more preferably 40 to 90% of the full charge amount.

Further, it is important that the electric capacity of the power supply source not be lower than a predetermined level in order to be able to comply with use where starting and ending of operation are repeated and to also comply with the case where electronic equipment requires power significantly exceeding the average power consumption thereof for a significantly long time period. Accordingly, in the case of electronic equipment, e.g., of a notebook personal computer, it is not enough that the power storage source has electric capacity for starting its operation only once. The power storage source is preferred to have an electric capacity for being capable of starting operation of electronic equipment at least 5 times by itself.

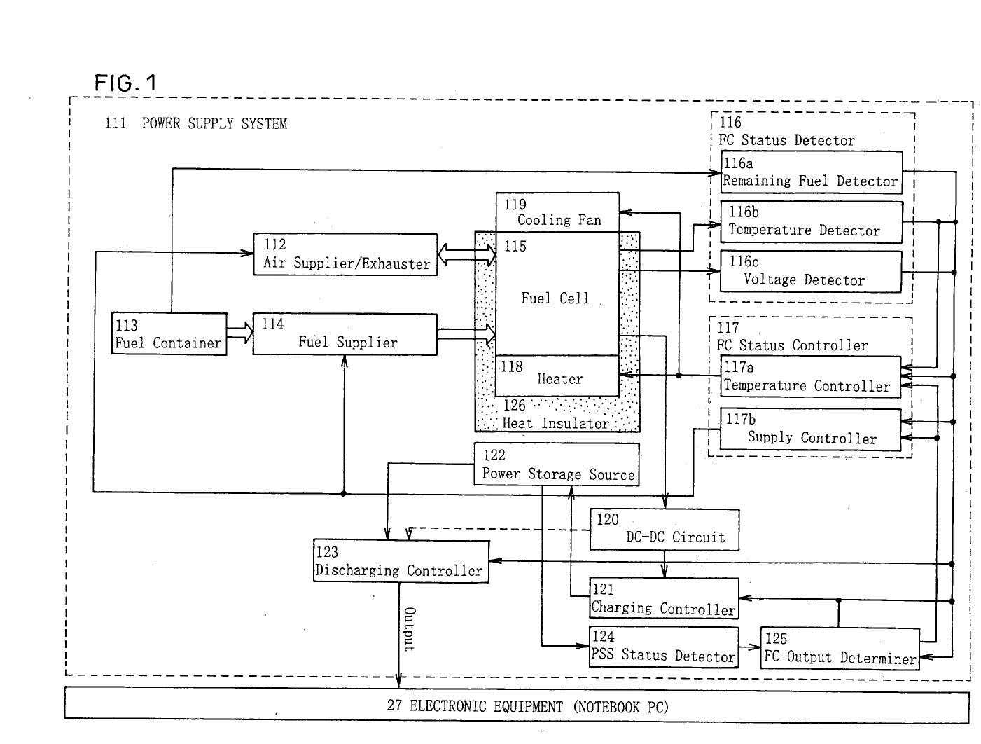

FIG. 1 is a schematic block diagram, showing a first preferred embodiment of a power supply system according to the present invention. As shown in FIG. 1, the power supply system 111 according to the present embodiment comprises: a fuel cell 115; an air supplier/exhauster 112 for supplying air to an air electrode of fuel cell 115, and for exhausting gas after the reaction within the fuel cell 115; a fuel container 113 for storing fuel such as methanol aqueous solution or hydrogen; a fuel supplier 114 for receiving fuel from the fuel container 113 and supplying the fuel to the fuel cell 115; and a power storage source 122 comprising at least one of a capacitor and a secondary battery such as but not limited to a lithium-ion battery.

The power supply system 111 further comprises a DC-DC circuit 120 coupled, at its input, to the fuel cell 115 for adjusting the voltage of the output power of the fuel cell 115 and applying the voltage-adjusted power to the power storage source 122; a discharging controller 123 coupled, at its input, to the power storage source 122 and, at its output, to the electronic equipment (portable equipment) 27 such as notebook personal computer for controlling the output from the power storage source 122 to the electronic equipment 27; a power storage source (PSS) status detector 124 coupled, at its input, to the power storage source 122 for detecting the remaining charge amount of the power storage source 122; a fuel cell (FC) output determiner 125 coupled, at its input, to the PSS status detector 124 for determining the output of the fuel cell 115 in response to the remaining charge amount of the power storage source 122; and a charging controller 121 coupled, at its input, to the FC output determiner 125 and the DC-DC circuit 120 and, at its output, to the power storage source 122 for charging the power storage source 122 with power from the fuel cell 115 via the DC-DC circuit 120 in response to the signal from the FC output determiner 125 to optimize the charging state of the power storage source 122.

The power supply system 111 further comprises: a fuel cell (FC) status detector 116 coupled, at its input, to the fuel cell 115 for detecting the status of the fuel cell 115; and a fuel cell (FC) status controller 117 coupled, at its input, to the FC status detector 116 and the FC output determiner 125 and, at its output, to the air supplier/exhauster 112 and the fuel supplier 114 for controlling the operational status of the fuel cell 115 in response to a signal from the FC output determiner 125 and in response to a signal from the fuel cell (FC) status detector 116.

The FC status detector 116 comprises: a remaining fuel detector 116a coupled, at its input, to the fuel container 113 for detecting the amount of fuel in the fuel container 113; a temperature detector 116b coupled, at its input, to the fuel cell 115 for detecting the temperature of the fuel cell 115; and a voltage detector 116c coupled, at its input, to the fuel cell 115 for detecting the output voltage of the fuel cell 115. These elements each function to send a signal to the FC status controller 117, the charging controller 121, the FC output determiner 125 and the discharging controller 123, thereby stopping the power supply system 111, when the value of the remaining fuel and/or the value of the voltage detected by the remaining fuel detector 116a and the voltage detector 116c, respectively, become lower than predetermined values, or when the temperature detected by the temperature detector 116b becomes higher than a predetermined value.

The FC status controller 117 comprises: a temperature controller 117a coupled, at its input, to the remaining fuel detector 116a, the temperature detector 116b and the FC output determiner 125 and, at its output, to a heater 118 and a cooling fan 119 for controlling the temperature of the fuel cell 115; and a supply controller 117b coupled, at its input, to the FC output determiner 125, the remaining fuel detector 116a, the temperature detector 116b and the voltage detector 116c and, at its output, to the air supplier/exhauster 112 and the fuel supplier 114 for determining the amount of air and fuel to be supplied to the fuel cell 115.

Regarding the temperature control, elements such as the temperature detector 116b and the temperature controller 117a function to set the fuel cell 115 at an optimum temperature in a manner that the temperature controller 117a controls the heater 118 and the cooling fan 119 in response to the temperature of the fuel cell 115 detected by the temperature detector 116b. The power supply system 111 further comprises a heat insulator 126 provided at the fuel cell 115 and the heater 118 for protecting the power storage source 122 from the heat of the fuel cell 115 and the heater 118.

According to the present embodiment, the maximum output of the fuel cell 115 is designed to be higher than the average power consumption and lower than the maximum power consumption of the electronic equipment 27 having, in use, the power supply system 111 mounted or secured thereon. The power storage source 122 is able to output power that is equal to or higher than the power corresponding to the maximum power consumption of the electronic equipment 27.

Generally, as the ambient temperature rises, deterioration of a power storage source is likely to be accelerated, whereby its life becomes shorter. On the other hand, a fuel cell can provide a higher output power at a higher temperature. If the temperature of the fuel cell is too high, it badly affects the power storage source for portable equipment in particular. So, a practically desired temperature in use is considered to be about 40° C. However, even at such a temperature, the life of the power storage source becomes significantly shorter than when at room temperature. For avoiding such a problem, in the present embodiment the power storage source 122 is thermally insulated from the fuel cell 115 using the heat insulator 126.

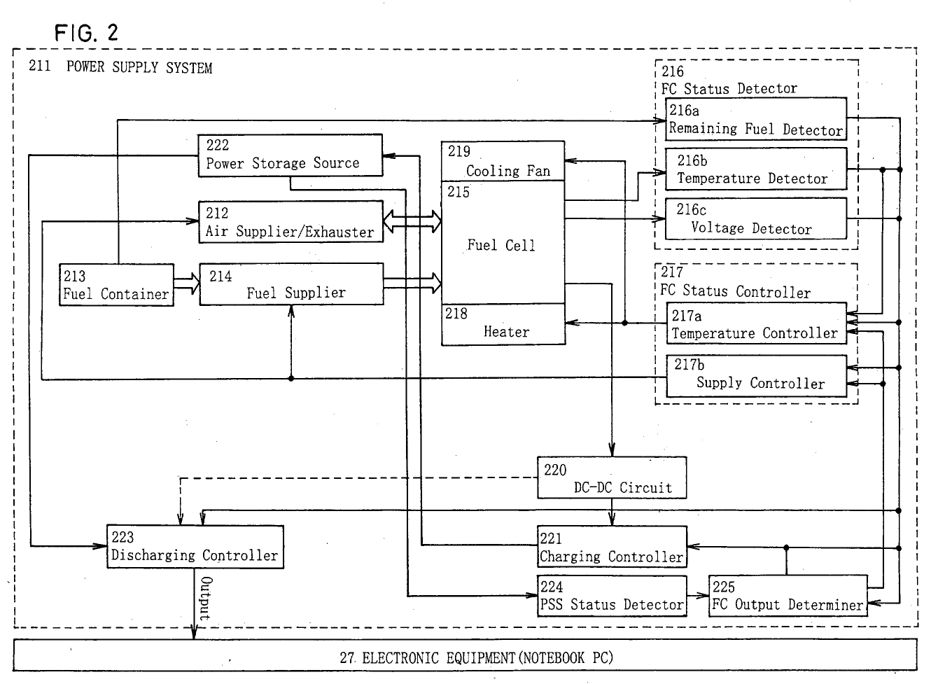

Another manner of the thermal insulation is shown in FIG. 2, in which the power storage source 222 is thermally insulated from the fuel cell 215 by spatially separating the power storage source 222 from the fuel cell 215. FIG. 2 is a schematic block diagram, showing a structure of a power supply system 211 in accordance with a second embodiment of the present invention. In FIG. 2, elements in the power supply system are designated by reference numerals of 3 digits, in which reference numerals having the same last two digits as those in FIG. 1 designate elements having like functions as those in FIG. 1. For example, reference numerals 216 and 217 in FIG. 2 designate a fuel cell (FC) status detector and a fuel cell (FC) status controller, respectively, like the FC status detector 116 and the FC status controller 117 in FIG. 1.

As in the power supply system 111 of FIG. 1, the power supply system 211 shown in FIG. 2 comprises: an air supplier/exhauster 212, a fuel container 213, a fuel supplier 214, a fuel cell 215, a cooling fan 219, a heater 218, an FC status detector 216 (remaining fuel detector 216a, temperature detector 216b and voltage detector 216c), an FC status controller 217 (temperature controller 217a and supply controller 217b), a DC-DC circuit 220, a charging controller 221, a power storage source 222, a discharging controller 223, a power storage source (PSS) status detector 224 and an FC output determiner 225. The output of the power supply system 211 (output of the discharging controller 223) is fed to the electronic equipment 27 such as portable equipment, for example a notebook personal computer.

The power supply system 211 as shown in FIG. 2 is designed so that the power storage source 222 is cooled, using air introduced by the air supplier/exhauster 212. Thereby, a significant cooling effect can be obtained.

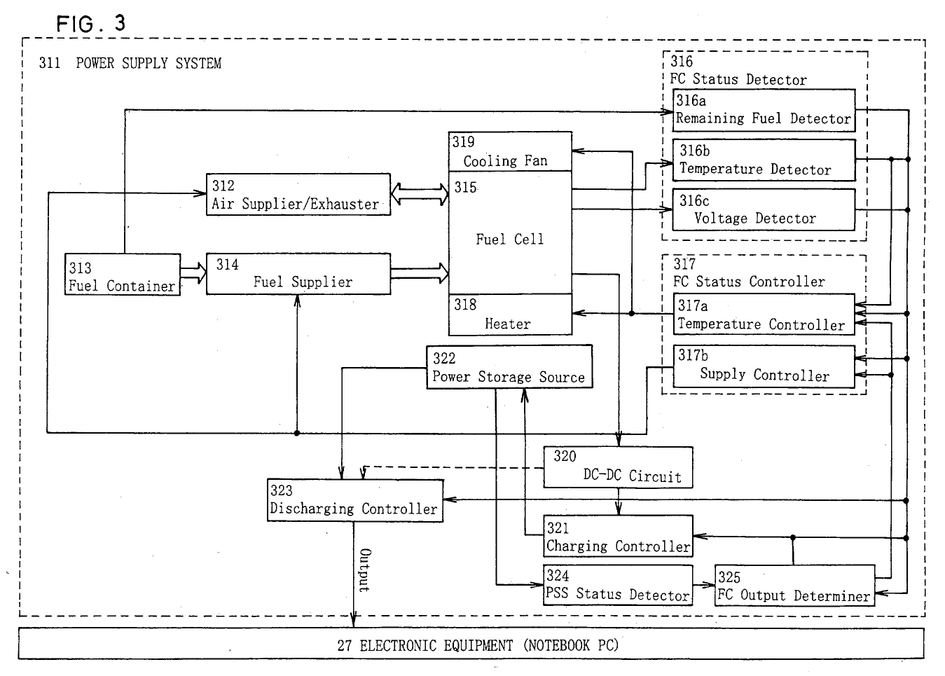

FIG. 3 is a schematic block diagram, showing the structure of a power supply system 311 according to a third preferred embodiment of the present invention. This power supply system 311 is operable according to the present invention, but is inferior to that of the power supply system shown in FIG. 1 or FIG. 3 with respect to thermal insulation as will be described later.

As in the power supply systems 111 and 211 in FIGS. 1 and 2, the power supply system 311 shown in FIG. 3 comprises: an air supplier/exhauster 312, a fuel container 313, a fuel supplier 314, a fuel cell 315, a cooling fan 319, a heater 318, an FC status detector 316 (remaining fuel detector 316a, temperature detector 316b and voltage detector 316c), an FC status controller 317 (temperature controller 317a and supply controller 317b), a DC-DC circuit 320, a charging controller 321, a power storage source 322, a discharging controller 323, a power storage source (PSS) status detector 324 and an FC output determiner 325. The output of the power supply system 311 (output of the discharging controller 323) is fed to the electronic equipment 27 such as portable equipment, for example a notebook personal computer.

In the power supply system 311 as shown in FIG. 3, the power storage source 322 is not thermally insulated from the fuel cell 315. Accordingly, the power storage source 322 is always exposed to an environment having a temperature of about 40° C. when the electronic equipment 27 is in use. The initial performance of the power supply system 311 of FIG. 3 is good, but the power storage source 322 deteriorates in a comparatively short time so that the operation of the power supply system 311 ceases in a comparatively short time.

In contrast, according to the power supply systems 111 and 211 as shown in FIGS. 1 and 2, the power storage sources 122 and 222 can have a life comparable to that of a power storage source as used in a conventional notebook personal computer, since the power storage sources 122 and 222 are thermally insulated from the fuel cells 115 and 215. The life of the power storage source can have a still longer life when the power storage source is also cooled, using air introduced by the air supplier/exhauster as shown in FIG. 2.

In the embodiments as shown in FIGS. 1, 2 and 3, the output of the fuel cell 115, 215 or 315 is basically fed or transferred to the power storage source 122, 222 or 322, via the DC-DC circuit 120, 220 or 320 and the charging controller 121, 221 or 321, for charging such power storage source, before being fed or transferred to the discharging controller 123, 223 or 323. However, a part of the output of the fuel cell can be directly fed or transferred to the discharging controller 123, 223 or 323 from the DC-DC circuit 120, 220 or 320 as shown by the dotted arrow lines in parallel with the power feeding line from the DC-DC circuit 120, 220 or 320, the charging controller 121, 221 or 321 and the power storage source 122, 222 or 323. An advantage of such additional power feeding line is that the amount of current for the power storage source 122, 222 or 322 to share (receive/supply) can be smaller.

As for a fuel to be supplied to a fuel cell, a mixture of methanol and water, for example, may be used. Alternatively, other hydrocarbon fuels such as ethanol, ethyleneglycol, dimethoxyethane (DME) and mixtures thereof or hydrogen can be used for obtaining similar results. Further, the liquid fuels can be preliminarily vaporized, and can be supplied to the fuel cell in the form of a vapor.

The temperature of the fuel cells according to the embodiments of the present invention is controlled to be about 40° C. by adjusting, for example, the amount of air supplied to the air electrode and the heaters 118, 218 and 318. Various heaters such as a rubber heater of a type known in the art can be used. From the viewpoint of total energy efficiency, it is preferable to use available or waste heat, for example, heat generated by the fuel cell per se and/or heat generated by various circuits in the electronic equipment for heating the fuel cell.

As for the power storage source, any power storage sources can be used such as a lithium-ion battery, a nickel-hydrogen battery, a nickel-cadmium battery and a capacitor. Among them, a lithium-ion battery is preferable for its electric capacity and small size.

The maximum output of a fuel cell significantly varies with temperature. The maximum output of the fuel cell as defined in the present specification is at a predetermined temperature of the fuel cell when mounted on electronic equipment (40° C. according to the present embodiments).

Hereinafter, non-limiting EXAMPLES employing the embodiments according to the present invention will be described with reference to the appended drawings.

### EXAMPLE 1 AND COMPARATIVE EXAMPLE 1

### Examples 1-1 to 1-7 and Comparative Examples 1-1 to 1-4

Power supply systems each having a structure as shown in FIG. 1 were made according to the present EXAMPLE 1 and COMPARATIVE EXAMPLE 1, except that the remaining fuel detector 116 was treated as if it did not exist.

(1) Preparation of Fuel Cell

Electrically conductive carbon particles having an average particle size of about 30 nm were allowed to carry platinum particles having an average particle size of about 30 Å, thereby obtaining catalyst-carrying carbon particles (platinum particles being 50 wt % of the total particle weight) for an air electrode. The same electrically conductive carbon particles were allowed to carry platinum particles having an average particle size of 30 Å and ruthenium particles having an average particle size of 30 Å, thereby obtaining catalyst-carrying carbon particles (platinum particles being 25 wt % and ruthenium particles being 25 wt % of the total particle weight) for a fuel electrode.

Next, a hydrogen ion conductive polymer electrolyte was mixed with the catalyst-carrying carbon particles for the air electrode and the catalyst-carrying carbon particles for the fuel electrode, respectively, thereby making catalyst pastes for the air and the fuel electrodes. In each of the catalyst pastes, the weight ratio of the carbon particles to the hydrogen ion conductive polymer electrolyte was 1:1.

Meanwhile, a hydrogen ion conductive polymer electrolyte membrane (Nafion™117: product of DuPont Company) was prepared. On one major surface of the polymer electrolyte membrane, the catalyst paste for the fuel electrode was printed, while the catalyst paste for the air electrode was printed on the other major surface of the electrolyte membrane. A gas diffusion layer for the fuel electrode and a gas diffusion layer for the air electrode were placed on the catalyst pastes for the fuel and the air electrodes, respectively, thereby making a sandwich of the electrolyte membrane, the catalyst pastes and the gas diffusion layers. This sandwich was hot-pressed to bond the respective elements, thereby making an electrolyte membrane-electrode assembly (MEA). The combination of the gas diffusion layer and the catalyst paste for the fuel electrode constitutes a fuel electrode, while the combination of the gas diffusion layer and the catalyst paste for the air electrode constitutes an air electrode. A carbon paper cut into two was used for the respective gas diffusion layers.

Next, gasket plates made of rubber were bonded onto peripheral portions of the hydrogen ion conductive polymer electrolyte membrane of the thus made MEA. The MEA with the gasket plates were sandwiched by separator plates (each graphite plate having a resin impregnated therein), each of which has a thickness of 3 mm and is provided with gas flow channels on both sides thereof by cutting. The resulting sandwich thereby made a unit cell.

By stacking a plurality of such unit cells, a fuel cell was made. Various fuel cells having various maximum outputs were made by varying the electrode area of each unit cell and varying the number of unit cells in the stack.

(2) Preparation of Power Supply System

A power supply system according to the present EXAMPLE (power supply system 111 as shown in FIG. 1, where the operation of the remaining fuel detector 116a is stopped, and where the connection as shown by the dotted arrow line is not made so that a part of the output of the fuel cell is not directly fed to the discharging controller 123 from the DC-DC circuit 120) was prepared, using a lithium-ion battery for a secondary battery constituting the power storage source 122 and one of the fuel cells as described in (1) above. The thus prepared power supply system was mounted on a notebook personal computer, as the electronic equipment 27, having a maximum power consumption of 50 W and an average power consumption of 10 W.

Using various lithium-ion batteries having various maximum outputs and selecting a fuel cell from among those as described in (1)above, seven power supply systems according to the present EXAMPLE 1 (power supply systems S1-1to S1-7 according to EXAMPLES 1-1 to 1-7) and four power supply systems according to COMPARATIVE EXAMPLE 1 (power supply systems CS1-1 to CS1-4 according to COMPARATIVE EXAMPLES 1-1 to 1-4) were prepared as listed in Table 1 below, where the maximum output of each fuel cell was at 40° C.

TABLE 1

| | | | | Maximum |
|---|---|---|---|---|
| EXAMPLE/ | | | Maximum | Output of |
| COMPARATIVE | | Power Supply | Output of | Lithium-ion |
| EXAMPLE | | System | Fuel Cell (W) | Battery (W) |
| EXAMPLE | 1-1 | S1-1 | 15 | 50 |
| | 1-2 | S1-2 | 20 | 50 |
| | 1-3 | S1-3 | 30 | 50 |
| | 1-4 | S1-4 | 15 | 60 |
| | 1-5 | S1-5 | 15 | 80 |
| | 1-6 | S1-6 | 15 | 100 |
| | 1-7 | S1-7 | 15 | 120 |
| COMPARATIVE | 1-1 | CS1-1 | 8 | 50 |
| EXAMPLE | 1-2 | CS1-2 | 15 | 35 |
| | 1-3 | CS1-3 | 50 | 10 |
| | 1-4 | CS1-4 | 50 | 50 |

(3) Evaluation of Results

In the case of power supply systems S1-1 to S1-7, the notebook personal computer could be operated until the fuel was consumed to its end. Further, by refilling the fuel cell, the power supply systems S1-1 to S1-7 could repeatedly be used. The output of the fuel cell was higher than the average power consumption of the notebook personal computer (electronic equipment) according to the power supply systems S1-1 to S1-7 of the present EXAMPLE. So, the charge amount of the lithium-ion battery could always be maintained at a constant level by transferring a part or all of the output of the fuel cell to the lithium-ion battery for charging it when the electric capacity of the lithium-ion battery decreased. Accordingly, the power supply systems according to the present EXAMPLE could continue to be used without regard to the remaining charge amount of the lithium-ion battery.

Further, in the power supply systems S1-1 to S1-7 according to the present EXAMPLE, the maximum output of the fuel cell was arranged to be lower than the maximum power consumption of the notebook personal computer, whereby the size and the cost of the fuel cell were small and low. Particularly in the case of the power supply systems S1-1 and S1-2 according to the present EXAMPLE, the size and the cost of the fuel cell, hence those of the power supply system, could be made significantly small and low, since the maximum output of the fuel cell was not higher than twice the average power consumption of the notebook personal computer.

Among the power supply systems according to the present EXAMPLE, the power supply system S1-3 was larger in size and higher in cost than those of the power supply systems S1-1 and S1-2, although it was smaller in size and lower in cost than those of Comparative power supply systems CS1-3 and CS1-4. This is because the maximum output of the fuel cell of the power supply system S1-3 exceeded 2 times and was 3 times the average power consumption of the notebook personal computer.

In the case of the power supply systems S1-4, S1-5 and S1-6, the maximum outputs of the lithium-ion batteries were 60 W, 80 W and 100 W, respectively, all higher than the maximum power consumption of the notebook personal computer. That is, the lithium-ion batteries had more than enough capacity or allowance of power. Because of the over capacity or allowance of power, the output of all such lithium-ion batteries were maintained to be not lower than 50 W, even when they deteriorated in use, whereby these power supply systems could be used for a long time.

When a lithium-ion battery having a maximum output of 50 W was used with the power consumption of 50 W of the notebook personal computer, the load of the notebook personal computer to the lithium-ion battery was too heavy, whereby the life of the lithium-ion battery was likely to become short. In contrast, when the lithium-ion battery having the maximum output of 100 W was used with the power consumption of the same 50 W, the load to the lithium-ion battery was comparatively light, whereby the life of the lithium-ion battery was sufficiently long, and the power supply system could be used for a long time.

From the viewpoint of capacity or allowance of power, the power supply system S1-7 having the maximum output of 120 W was good. However, such power supply system was considered so-called “overdesigned”, and thus was inferior to the power supply systems S1-4, S1-5 and S1-6 in view, e.g., of cost.

On the other hand, in the case of the Comparative power supply system CS1-1, it was not possible to continue operating the notebook personal computer until the fuel was consumed to its end. Even by refilling the fuel, it was not possible to resume the operation of the notebook personal computer. This was because sufficient power could not be supplied to the notebook personal computer having the average power consumption of 10 W, whereby the lithium-ion battery became fully discharged. The lithium-ion battery had a potential power of 50 W, but could not supply an output when fully discharged. Accordingly, the operation of the notebook personal computer could not be started thereafter.

Next, in the case of the Comparative power supply system CS1-2, the operation of the notebook personal computer could not be started. This is because at the time of starting the operation, the temperature of the fuel cell was below 40° C., and hence the fuel cell could not supply an output of 15 W, although the combination of the fuel cell and the lithium-ion battery had a total potential output of 50 W. The reason for the inability of starting the operation of the notebook personal computer was also considered with respect to the notebook personal computer side, in which all of a hard disk, CD-ROM, CPU and a liquid crystal display required a power at the same time that was a power substantially comparable to the maximum power consumption of 50 W. By adopting such an arrangement as to first warm the fuel cell, using the lithium-ion battery, and then start the operation of the electronic equipment, it was possible to start the operation of the electronic equipment. However, such arrangement was considered disadvantageous because it needed a long time for starting the operation, particularly at a low ambient temperature.

Furthermore, the Comparative power supply systems CS1-3 and CS1-4, which could secure the output of 50 W by the fuel cell alone, undesirably required the fuel cell to be large in size, e.g. 3 times or more larger than that in the power supply systems according to the present EXAMPLE, for example the power supply system S1-1. Thereby, the total size of the power supply system became large, e.g., 2 times or more larger than the power supply system S1-1 .

These Comparative power supply systems CS1-3 and CS1-4 further had a problem in cost in that the electrode area of the fuel cell needed to be large, whereby the expensive electrolyte membranes and platinum group catalysts of 3 times or more larger in quantity than those, e.g., of the fuel cell in the power supply system S1-1 were needed, resulting in a cost of 2 times or more higher than that of the fuel cell in the power supply system S1-1. Further, the Comparative power supply system CS1-3 had a problem in that the operation of the notebook personal computer could not be started thereby, just as in the case of the power supply system CS1-2.

From the above results, it has been found to be important that the fuel cell has a maximum output power which is higher than the average power consumption of and lower than the maximum power consumption of the electronic equipment, and that the power storage source can output at least power corresponding to the maximum power consumption of the electronic equipment.

Further, although the size or volume and cost of the fuel cell increases as the maximum output of the fuel cell increases, it has been found by calculations based on the power supply systems according to the present EXAMPLE that a power supply system which is competitive as to size or volume and cost as compared with the lithium-ion battery used in the current notebook personal computers can be designed, if the maximum output of the fuel cell is not higher than twice the average power consumption of the notebook personal computer or electronic equipment. Thus, it has been found desirable that the maximum output of the fuel cell is not higher than twice the average power consumption of the electronic equipment.

Further, although the capacity or allowance of the power storage source increases as the maximum output of the power storage source increases, it has been found preferable that the power storage source have a maximum output not higher than twice the maximum power consumption of the electronic equipment in view, e.g., of the cost of the entire power supply system.

### EXAMPLE 2

Examples 2-1 to 2-3

A power supply system 211 having a structure as shown in FIG. 2 (power supply system S2-1 according to the present EXAMPLE 2-1) was made in a manner similar to that in EXAMPLE 1, except that here a power storage source 222 is spatially separated from a fuel cell 215, and a cooling arrangement was adopted such that the power storage source could be cooled, using air introduced by an air supplier/exhauster 212.

Further, a power supply system 311 having structure as shown in FIG. 3 (power supply system S2-2 according to the present EXAMPLE 2-2) was made in a manner similar to that in EXAMPLE 1, except that here the heat insulator 26 was not provided.

In the case of the power supply system S2-1 as shown in FIG. 2, a significant cooling effect could be obtained by cooling the power storage source 222, using the air introduced by the air supplier/exhauster 212.

On the other hand, in the case of the power supply system S2-2 as shown in FIG. 3, the power storage source 322 was always exposed to an environment of about 40° C. when the notebook personal computer (electronic equipment) 27 was in use, since the power storage source 322 was not thermally insulated from the fuel cell 315. Thus, the power storage source 322 deteriorated in a comparatively short time. Although the initial performance of the power supply system 322 was good, it became inferior to those of the power supply systems S1-1 and S2-1 as the power supply system 322 was continuously used for a long time.

In contrast thereto, the power supply systems 111 (e.g. power supply system S1-1) and 211 (S2-1) could have lives comparable to those of lithium-ion batteries as used for the power storage sources in a conventional notebook personal computers, since the lithium-ion batteries 122 for the power storage sources 122 and 222 are thermally insulated from the fuel cells 115 and 215.

Next, a power supply system 111 as shown in FIG. 1 was made (power supply system S2-3 according to the present EXAMPLE 2-3) in a manner similar to that in EXAMPLE 1, except that here the remaining fuel detector 116a which was not operated in EXAMPLE 1 (e.g. power supply system S1-1 according to EXAMPLE 1-1) was operated, wherein the remaining fuel detector 116a has an operational function of stopping the power supply system 111 when the fuel container 113 for the fuel cell 115 becomes empty. In the case of this power supply system S2-3, it was possible to resume the operation thereof after the fuel container 113 became empty of its fuel, and was then refilled with the fuel, just as it was possible in the case of the power supply systems S1-1 to S1-7 in EXAMPLE 1. This was because just as in the case of the power supply systems S1-1 to S1-7, the lithium-ion battery in the power supply system of example S2-3 still retained a charge amount while the operation of the fuel cell of example S2-3 was stopped.

In contrast, when this mechanism or function of stopping the power supply system on the basis of the remaining fuel detection was not operated, the lithium-ion battery was used until the battery consumes or loses its charge amount after the fuel (in the fuel container 113) is consumed to its end. So, the power supply system without operating the stopping mechanism on the basis of the remaining fuel had a problem in that the operation of such power supply system could not be started again, using the lithium-ion battery.

As evident from the foregoing descriptions including the EXAMPLES, good results and effects could be obtained by a power supply system comprising a fuel cell and a power storage source comprising at least one of a secondary battery and a capacitor, the power supply system being secured to or mounted, in use thereof, on an electronic equipment, wherein: the fuel cell has a maximum output power which is higher than the average power consumption of and lower than the maximum power consumption of the electronic equipment; and the power storage source can output at least a power corresponding to the maximum power consumption of the electronic equipment. More specifically, such power supply system can start the operation of electronic equipment having a high starting load, irrespectively of the ambient temperature; can operate the electronic equipment for a long time by simply refilling the fuel supply to the fuel cell; and can be low in cost, small in size and high in reliability and output energy density.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

We claim:

1. A power supply system comprising a fuel cell and a power storage source comprising at least one of a secondary battery and a capacitor, said power supply system being secured, in use thereof, to an electronic equipment, wherein: said fuel cell has a maximum output power which is higher than an average power consumption of and lower than a maximum power consumption of said electronic equipment; and said power storage source can output at least a power corresponding to said maximum power consumption of said electronic equipment.

2. The power supply system according to claim 1, wherein said maximum output power of said fuel cell is not higher than twice said average power consumption of said electronic equipment.

3. The power supply system according to claim 1, wherein said power storage source has a maximum output power which is not higher than twice said maximum power consumption of said electronic equipment.

4. The power supply system according to claim 1, wherein said power storage source has an electric capacity capable of starting the operation of said electronic equipment at least five times.

5. The power supply system according to claim 1, wherein said power storage source is thermally insulated from said fuel cell.

6. The power supply system according to claim 5, wherein said power storage source is thermally insulated from said fuel cell by a space provided between said fuel cell and said power storage source.

7. The power supply system according to claim 5, wherein said power storage source is thermally insulated from said fuel cell by a heat insulator provided between said fuel cell and said power storage source.

8. The power supply system according to claim 1, which further comprises a cooling means for cooling said power storage source, using air supplied to said fuel cell.

9. The power supply system according to claim 1, which further comprises a controller which detects the amount of fuel supplied to said fuel cell, and which stops the output of said power supply system when the supplied fuel is detected to have become exhausted.

10. Electronic equipment having the power supply system of claim 9 secured thereto.

11. Electronic equipment having the power supply system of claim 1 mounted thereon.

12. The power supply system according to claim 1, wherein the electronic equipment is portable.

13. The power supply system according to claim 1, wherein the electronic equipment is one of a notebook personal computer, a personal digital assistant and a cellular phone.

14. The power supply system according to claim 1, wherein the power storage source comprises one of a lithium-ion battery, a nickel-hydrogen battery, a nickel-cadmium battery and a capacitor.
